(19) United States
(12) Patent Application Publication
(10) Pub. No.: US 2019/0074036 A1
(43) Pub. Date: Mar. 7, 2019

(54) SYSTEM AND METHOD FOR LIVE VIDEO PRODUCTION MONITORING AND ANNOTATION

(71) Applicant: Zullavision, Inc., Hollywood, CA (US)

(72) Inventors: Aviram COHEN, Gealya (IL); Charles Booey KOBER, Los Angeles, CA (US); Eytan KELLER, Los Angeles, CA (US); Yoav NISSAN-COHEN, Mishmar David (IL)

(73) Assignee: Zullavision, Inc., Hollywood, CA (US)

(21) Appl. No.: 15/989,780

(22) Filed: May 25, 2018

Related U.S. Application Data
(63) Continuation-in-part of application No. 15/922,008, filed on Mar. 15, 2018.
(60) Provisional application No. 62/573,631, filed on Oct. 17, 2017.
(60) Provisional application No. 62/553,369, filed on Sep. 1, 2017.

(51) Int. Cl. G11B 27/036; G11B 27/36; H04N 5/222; H04N 5/28; G11B 27/10

(52) U.S. Cl. CPC G11B 27/036; G11B 27/36; G06F 3/167; H04N 5/28; G11B 27/10; H04N 5/2228

(57) ABSTRACT

An interactive live video production monitoring and control system is provided. The system includes a base station, connected to audio and video sources, that transmits live audio and video to an interactive mobile tablet using low-latency wireless communication. The mobile tablet displays the audio and video feeds of single or multiple audio and video sources with imperceptible delay. It allows users in the production team to roam freely throughout the production environment, while interacting directly with other users in the production environment and or remotely with other off-site members of the team. Users can interact with each other while viewing, recording and annotating the video feeds. The mobile tablet incorporates an ultra-low-latency wireless link. The mobile tablet allows users to view, record and playback live audio and video from one or multiple audio and video sources. Users can instantly annotate the live video and textual documents, as well as view and annotate the recorded video. All of the annotations and textural documents are always in sync with the recorded content. The system enables audio, video and metadata collaboration between users on the production site and off-site users.

### PRIORITY CLAIM

The present application is a continuation in part of U.S. patent application Ser. No. 15/922,008, entitled “System and Method for Live Video Production Monitoring and Annotation,” filed Mar. 15, 2018, the entirety of which is hereby incorporated by reference.

The present application also claims priority to U.S. Provisional Patent Application No. 62/553,369, entitled “System and Method for Live Video Production Monitoring and Annotation,” filed Sep. 1, 2017, and U.S. Provisional Patent Application No. 62/573,631, entitled “System and Method for Live Video Production Monitoring and Annotation,” filed Oct. 17, 2017, the entireties of which is hereby incorporated by reference.

### TECHNICAL FIELD

The present invention relates generally to the field of video monitoring and recording, and, as an example, to the live monitoring of a video production such as television, film or an event.

### BACKGROUND

The director of a television or film video production has a difficult, complex, multi-faceted task. The director can manage hundreds of people including actors, camera crew, stage crew, lighting crew, sound crew. During shooting, the director wants to capture the best possible video using multiple video and film cameras and other video and imagery sources that provide different angles and have different lenses that enable multiple fields of view. After shooting, the director will edit the video captured by the cameras and the other sources of imagery to create a high-quality production.

Today's directors find it difficult to monitor the cameras and other sources of imagery in real-time while simultaneously watching the recorded content and freely moving around the production set interacting with actors and crew. This is a daunting task for directors as well as other members of the creative team.

Most video productions are based on a script that is maintained in digital format in a computer file. A script file is generally a screenplay document, written for a film, video game, or television program. The script can be drafted to narrate the movement, actions, expressions, and dialogues of the characters within the film, video game, or television program. Scripts are usually divided into multiple scenes and the production team generally records one scene at a time. Typically, the production team records each scene and parts of each scene multiple times. A new scene recording is usually called a video-take. Within a video-take, the actors often go back to repeat an earlier part of the scene, while the cameras are still recording. For the purposes of this disclosure, there are multiple video-shootings within the video-take.

The director, and other production team members, select the best video-takes and video-shootings and combine them to produce the final video production. Directors typically want to ensure that different video-shootings have continuity, which requires that there not be disturbing visual or other differences between video-shootings. An exemplary difference is an actor that has the top-button of his shirt unbuttoned in one video-shooting and buttoned in another. Checking for discontinuities during a video recording session is difficult using conventional systems. A script supervisor tries to keep track of the video recordings by annotating the script with recording times. When the director wants to check for continuity, he or she asks the script supervisor to locate the video for relevant video-shootings. The script supervisor estimates when the relevant recordings took place. In many cases, the director goes to one or more cameras and plays back video from the estimated times. This review process is time-consuming. Directors typically dislike playing back video on the cameras because there is a risk that the camera configuration may change and a risk that some recorded video could be over-written during the next video-take. In most cases, the director would rather continue than take the time and risk of reviewing a prior recording.

As a result, there is a need to reduce the shooting time while increasing efficiency. Ideal solutions of this increased efficiency can include allowing all members of the creative team to more easily monitor the live cameras and the recorded content either together or separately.

### BRIEF DESCRIPTION OF THE DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings.

FIG. 1 is an exemplary diagram showing an embodiment of a system for live video production monitoring and annotation in accordance with one embodiment of the invention.

FIG. 2 is an exemplary diagram showing an embodiment of the mobile tablet in accordance with one embodiment of the invention.

FIG. 3a is an exemplary picture showing the front-view of an embodiment of the mobile tablet in accordance with one embodiment of the invention.

FIG. 3b is an exemplary picture showing the rear-view of an embodiment of the mobile tablet in accordance with one embodiment of the invention.

FIG. 4 is an exemplary flow chart showing a process for monitoring and annotating live video in the system in accordance with one embodiment of the invention.

FIG. 5 shows exemplary screenshots of a mobile platform.

FIG. 6 is a schematic view of an exemplary screenshot of a script being synchronized with live video in accordance with one embodiment of the invention.

FIGS. 7A-7C are schematic views illustrating a script being synchronized with video in accordance with one embodiment of the invention.

FIG. 8 is a flow chart illustrating a method for synchronizing live video with a script in the system in accordance with one embodiment of the invention.

FIG. 9 is a schematic view illustrating an exemplary shooting report in accordance with one embodiment of the invention.

### DETAILED DESCRIPTION

The system provides interactive, live video production monitoring and control. The system contains a base station, connected to audio and video sources, that transmits live audio and video to one or more mobile tablets using ultra-low-latency wireless communication. The mobile tablet displays the audio and video feeds of a single or multiple audio and video sources with imperceptible delay. The mobile tablet allows users in the production team to roam freely throughout the production environment, while interacting directly with other users in the production environment and or remotely with other off-site members of the team. Users can interact with each other while viewing, recording and annotating the video feeds. The mobile tablet incorporates an ultra-low-latency wireless link allowing mobile tablet users to experience a worst-case latency of 7 video frames and in some cases only a one video frame latency. The mobile tablet allows users to view, record and playback live audio and video from one or multiple audio and video sources. Users can instantly annotate the live video and any textual documents, as well as playback and annotate the recorded audio and video. The system enables audio, video and metadata collaboration between users on the production site and off-site users, anywhere in the world.

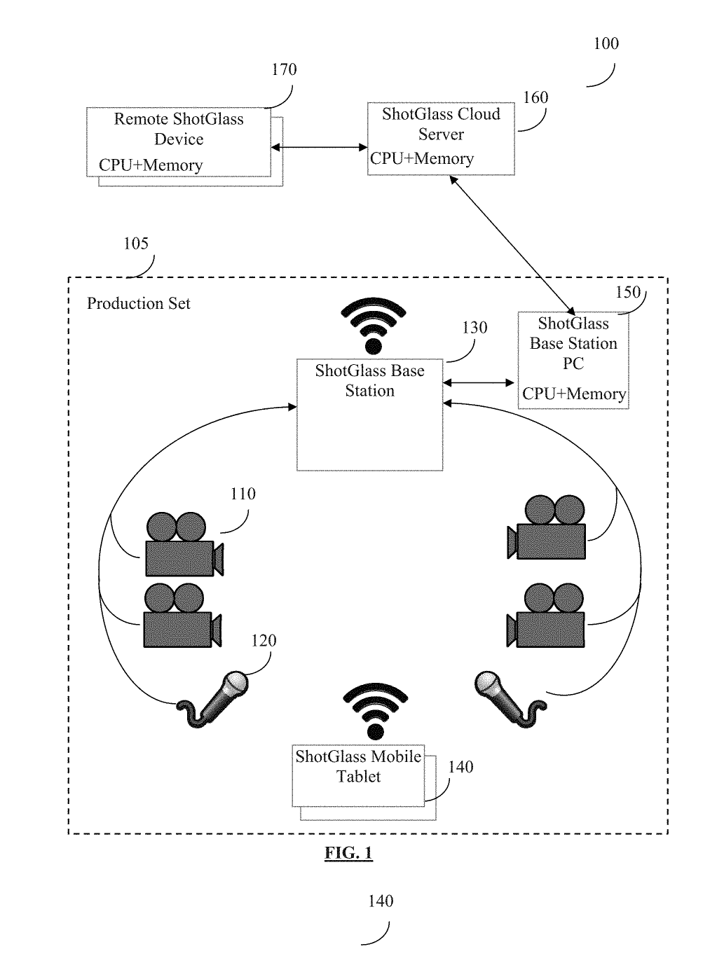

FIG. 1 is an exemplary diagram 100 showing an embodiment of the system for live video production monitoring and annotation. FIG. 1 illustrates an exemplary production set 105. In FIG. 1, the production set 105 includes one or more video cameras 110, one or more microphones 120, a base station 130, one of more mobile tablets 140 and a base station PC 150. In this example embodiment, the SHOTGLASS™ base station PC 150 communicates with a remote cloud server 160. The base station PC 150 also communicates with the base station 130. Remote users interact with a remote device 170 that communicates with the remote cloud server 160.

The video camera 110 records high-quality video, called the master copy, which is stored locally at the camera, by the camera itself or by an external storage device. The video camera 110 sends a live copy of the video to the base station 130. In addition to supporting video cameras, the system supports other types of video sources including, but not limited to, tape storage units and teleprompters. The system supports multiple types of video cameras with different video parameters including resolution, frame rate, video format and video bit depth. In one configuration, the video camera 110 records 60 frames per second, with 1080P resolution, 8-bit RGB data. In the example of FIG. 1, the video camera 100 has a wired connection to the base station 130. In a second embodiment, the video camera 100 communicates wirelessly to the base station 130.

In one configuration, the base station 130 combines the individual video camera feeds to create a single composite video feed. For example, the base station 130 may receive four 1080P video feeds from four different video cameras and produce a single 1080P video feed with 4 quadrants. Each quadrant shows the video from one of the four video cameras at reduced resolution. In a second configuration, the base station 130 sends the full resolution video camera feed from a specified video camera.

The microphone 120 records sound and sends the live sound recording to the base station 130 over a wired or wireless communication channel. The base station 130 receives live video from the video cameras 110 and audio sound from microphones 120.

The base station 130 transmits synced video and audio to the mobile tablets 140 with negligible delay. The base station 130 is configured to send either high-quality, full-resolution video or lower-quality proxy video to the mobile tablets 140. The base station 130 also has the option to send lower-quality video, called proxy video, to other devices in the network. In one embodiment, the base station 130 sends lower-quality, compressed video to the remote cloud server 160, which is then accessed by remote users using remote device 170.

In some embodiments, the base station 130 transmits audio and video containing an embedded time-code. The time-code defines the recording time and, together with video camera or microphone identifier, uniquely identifies the video and audio on a frame by frame basis. The video time-codes are generated by the video cameras, by a time-code generator or generated internally by the tablet, so that the time-codes captured by the system are the same time-codes which are embedded in the master copies of the recorded content. If multiple video cameras generate time-codes, the video cameras are synchronized so that each video camera generates the same time-code for the same interval. In another embodiment, a time-code synchronization device is attached to each video camera. Similarly, the audio time-codes are generated by a time-code generator or generated internally by the tablet and synchronized to match the video time-codes. The mobile tablet has an option to visually display the time-code, as an overlay on the content being recorded on the tablet. In one embodiment, the tablet will not record any content unless it's synchronized to either an external source of time-code or the tablet's internal clock.

The base station 130 contains an ultra-low latency chipset for wireless communication such as that developed and sold by the company Amimon™. The Amimon™ chipset utilizes Joint-Source-Channel-Coding (JSCC) algorithms developed specifically to enable zero delay delivery of high-definition and ultra-high-definition video. When the base station 130 sends the full resolution video camera feed (from a single video camera) the mobile tablet user will typically experience a one video frame delay. When the base station 130 generates and sends a composite feed the mobile tablet user will experience a longer latency. Decimating and compositing the video introduces additional latency.

In one embodiment, the base station 130 contains a video capture card and logic implemented in a FPGA or integrated circuit. In this embodiment, the base station 130 may also contain memory. In a second embodiment, the base station 130 also includes a CPU, memory and storage. The CPU may include processors, microprocessors, microcontrollers, digital signal processors (DSPs), field-programmable gate arrays (FPGAs), analog and/or digital application-specific integrated circuits (ASICs), or the like, or combinations thereof. The CPU may generally execute, process, or run instructions, code, code segments, software, firmware, programs, applications, apps, processes, services, daemons, or the like, or may step through states of a finite-state machine, or combinations of these actions. The CPU may be in communication with the other electronic components through serial or parallel links that include address busses, data busses, control lines, and the like. In some configurations, the CPU may consist of a single microprocessor or microcontroller. However, in other configurations, the CPU may comprise a plurality of processing devices (e.g., microprocessors, DSPs, etc.). The memory and storage may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage may include, or may constitute, a “computer-readable medium”. The storage may store the instructions, code, code segments, software, firmware, programs, applications, apps, services, daemons, or the like that are executed by the CPU. The storage may also store settings, data, documents, sound files, photographs, movies, images, databases, and the like.

In an alternate embodiment to that shown in FIG. 1, the base station 130 may be adapted to perform the functions of the base station PC 150 (i.e., the base station PC 150 is not required in the alternate embodiment).

The mobile tablet 140 receives live video and audio from the base station 130 over a special, low-latency wireless connection. This allows users to be able to monitor the live video sources on the mobile tablet 140 without a noticeable delay between what the users are seeing live and the view they see on the mobile tablet 140.

In normal operation, the mobile tablet 140 displays live and recorded video on its display screen. Users can decide if they want to hear the audio, either live or in playback mode. Users can select to hear multiple audio sources that are synced to the live and recorded video. These sources can be heard all together or listened to in various configurations, as selected by the user.

The mobile tablet 140 has controls for selecting which single video source, in a multi-view configuration to view full screen. For example, double tapping the desired single video source that appears in a multi-view configuration causes the mobile tablet 140 to switch to the indicated single video source and display it full screen. In one configuration, the base station 130 accepts a command from the mobile tablet 140 causing the base station 130 to change the transmitted video feed. In a second configuration, the mobile tablet 140 changes its display by itself splitting the incoming video stream into its component video camera feeds and selecting the appropriate component video camera feed.

The mobile tablet 140 has controls for starting and stopping recording. While recording is active, the mobile tablet 140 stores audio and video to its local storage. At any point in time, either while recording or at any time after, a user can access playback of recorded video and audio. Having local storage allows a mobile tablet user to playback audio and video regardless of the availability of wireless connectivity.

The mobile tablet 140 has an option to synchronize recordings with other mobile tablets 140. If a first mobile tablet user starts recording before a second mobile tablet is powered on (or if the second tablet is outside of the wireless reception area), the second mobile tablet will request the recorded data from the first mobile tablet or from the base station. In some embodiments, the mobile tablets 140 communicate with each other using WiFi connections. It will be appreciated that other communication methods may be used to connect the mobile tablets 140 such as, for example, Bluetooth™, peer-to-peer connection, etc.

The mobile tablet 140 can also have controls for annotating the video. The users typically define a number of different things, including but not limited to: a) which video sequences should be included in the final production; b) which video sequences should be excluded from the final production; c) which video sequences should be used for a promotional trailer; and/or d) which video sequence needs artwork or special effects to be added. Users select video marker icons displayed on the mobile tablet 140 to label different types of video sequences. Each user can annotate video with one or more markers as well as adding textual comments. When a user annotates the video with a marker, the mobile tablet 140 generates and displays a low-resolution, still image generated from the first frame of the selected video. Users can add free-hand, graphical annotation by telestrating over the still images in multiple colors. The low-resolution, still image is shown on a time-line. The mobile tablet 140 has pre-defined marker types and allows users to define new types of marker. Users can categorize the different marker types in different ways, such as, for example, by department. Users can annotate the video with markers under multiple scenarios including: a) annotating live video as the video is being recorded; b) playing back recorded video and annotating it; and c) during live recording, starting playback of recorded video, annotating the playback video, and then returning to viewing the live video. The information defined by the different marker types is known as metadata. The time-code identifies the location of the metadata on the video sequence. Different users can independently annotate the video. The mobile tablet 140 automatically shares and synchronizes metadata between different mobile tablets and with the remote cloud server 160.

In some embodiments, the mobile tablet 140 displays different categories of low-resolution, still images that correspond to user-defined marker locations. If a user clicks on a low-resolution still image, the mobile tablet plays back the corresponding video and audio, as well as identifying the camera, microphone, take number and time-code. Users may generate an email from the mobile tablet 140 that references one or more markers directly from the tablet. The sent document automatically indicates the sender's name, the production name, the scene name, the take number, the date, and the time-code address of the content that relates to this marker and syncs with the recorded content. The email receiver views the appropriate audio and video by selecting a marker embedded in the email.

The mobile tablets 140 communicate with the remote cloud server 160 using a regular WiFi™ connection to access the wide area network (WAN). It will be appreciated that other communication connects can be used for communication between the mobile tablets 140 and the cloud server 160.

After the recordings are concluded, the users can review the recordings. Users can add more markers as well as textual and/or graphical notes or comments. All of these become part of the available metadata.

FIG. 1 shows a base station PC 150 connected to a base station 130 and communicating over the WAN with a remote cloud server 160. The base station PC 150 transmits the audio and video from the base station 130 to the cloud server 160. The base station PC 150 compresses the audio and video before sending it over the WAN. The base station PC 150 supports multiple, standard, audio and video codecs and transport formats including, for example, H.264 and AC3.

In some embodiments, the base station PC 150 is a standard personal computer with a single or multi-core CPU, memory and storage. The CPU may include processors, microprocessors, microcontrollers, digital signal processors (DSPs), field-programmable gate arrays (FPGAs), analog and/or digital application-specific integrated circuits (ASICs), or the like, or combinations thereof. The CPU may generally execute, process, or run instructions, code, code segments, software, firmware, programs, applications, apps, processes, services, daemons, or the like, or may step through states of a finite-state machine, or combinations of these actions. The CPU may be in communication with the other electronic components through serial or parallel links that include address busses, data busses, control lines, and the like. In some configurations, the CPU may consist of a single microprocessor or microcontroller. However, in other configurations, the CPU may comprise a plurality of processing devices (e.g., microprocessors, DSPs, etc.). The memory and storage may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage may include, or may constitute, a “computer-readable medium”. The storage may store the instructions, code, code segments, software, firmware, programs, applications, apps, services, daemons, or the like that are executed by the CPU. The storage may also store settings, data, documents, sound files, photographs, movies, images, databases, and the like.

In some embodiments, the base station PC 150 has a wired connection to a router communicating with the WAN and a wired connection to the base station 130. In some embodiments, the base station PC 150 has one or more wireless connections.

The remote cloud server 160 may be one or more computers or server computers, the computers having one or more processors, memory and storage. The CPU may include processors, microprocessors, microcontrollers, digital signal processors (DSPs), field-programmable gate arrays (FPGAs), analog and/or digital application-specific integrated circuits (ASICs), or the like, or combinations thereof. The CPU may generally execute, process, or run instructions, code, code segments, software, firmware, programs, applications, apps, processes, services, daemons, or the like, or may step through states of a finite-state machine, or combinations of these actions. The CPU may be in communication with the other electronic components through serial or parallel links that include address busses, data busses, control lines, and the like. In some configurations, the CPU may consist of a single microprocessor or microcontroller. However, in other configurations, the CPU may comprise a plurality of processing devices (e.g., microprocessors, DSPs, etc.). The memory and storage may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage may include, or may constitute, a “computer-readable medium”. The storage may store the instructions, code, code segments, software, firmware, programs, applications, apps, services, daemons, or the like that are executed by the CPU. The storage may also store settings, data, documents, sound files, photographs, movies, images, databases, and the like.

The remote cloud server 160 stores a copy of the compressed audio and video for remote users to access. The remote cloud server 160 supports multiple production sets and can connect to multiple base station PCs over a WAN. In one embodiment, there are multiple remote cloud servers 160 which can be located in different places.

Remote users interact with a remote device 170 that communicates with the remote cloud server 160. The remote device 170 may be a desktop computer, laptop, tablet or other form of computer with one or more processors, memory and storage. In one particular embodiment, the remote device 170 is a mobile tablet. Remote users can playback video and audio, review metadata and add their own metadata.

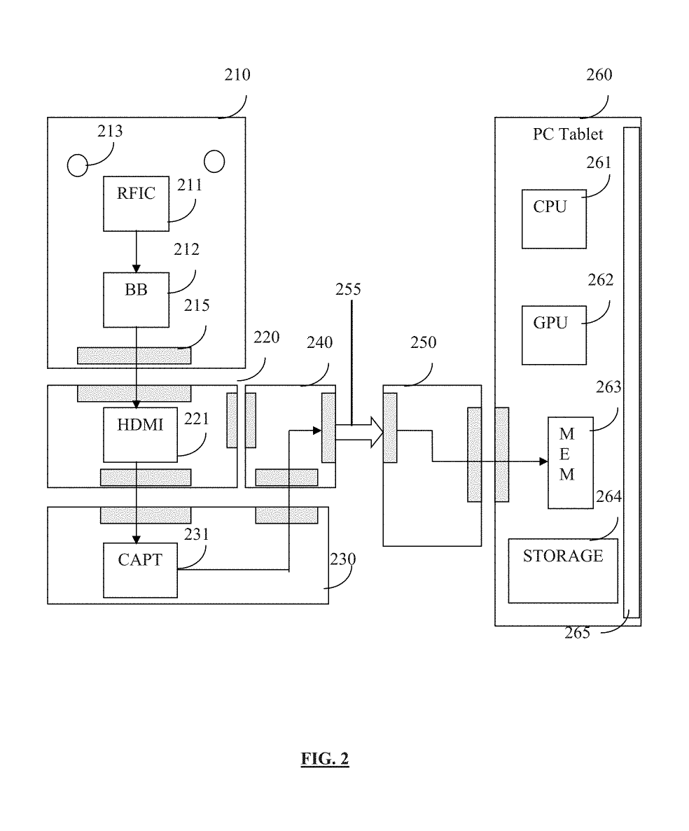

FIG. 2 is an exemplary diagram 140 showing an embodiment of the mobile tablet. In FIG. 2 the mobile tablet is implemented using a standard PC tablet 260 augmented with PC boards 210-250. PC boards 210-250 have connectors 215 for connecting the boards together.

PC board (wireless board) 210 receives video and audio from the base station using a wireless connection. The wireless board 210 contains an ultra-low latency chipset for wireless communication. Wireless board 210 contains a radio-frequency integrated circuit (RFIC) 211 connected to one or more antennas 213. The RFIC 211 drives the baseband integrated circuit (BB) and produces digital audio and video data.

HDMI board 220 converts the data output from wireless board 210 into HDMI format suitable for the standard video capture board 230. The HDMI board 220 may include an HDMI chip 221. A standard HDMI chip 221 may be used. The HDMI chip 221 converts received RGB data into an HDMI format for use by the video capture board 230.

The video capture board 230 captures video on the tablet. The video capture board 230 includes a video capture chip 231. The video capture chip 231 converts the HDMI video data into PCI format.

Height extender board 240 compensates for differences in height between the boards. It will be appreciated that the height extender board 240 is optional and is used as needed as understood by persons of skill in the art.

The Mini PCI Express Adapter board 250 connects to the height extender board 240 using a special, PCI cable 255. The special, PCI cable 255 connects the pins of the height extender board 240 to the pins of the Mini PCI Express Adapter board 250. The special, PCI cable 255 is designed to have appropriate length and to avoid noise on the cable wires. The Mini PCI Express Adapter board 250 plugs into a PCI connector slot on the standard PC tablet 260. The Mini PICI Express Adapter board 250 connects the functionality of PC boards 210-230 to the PC tablet 260.

The PC tablet 260 includes a CPU 261, a graphics processing unit (GPU) 262, memory 263 and storage 264. The video and audio data are sent to the memory 263 of the standard PC tablet 260. The graphics processing unit (GPU) 262 displays the video on the touch-screen 265. The PC tablet 260 may also include a speaker 266 for playing audio. Alternatively, an audio playback device may be connected externally, e.g., as headphones to the PC tablet 260 for playing audio. The CPU 261 executes software instructions contained in storage 264. Storage 264 holds video, audio, text documents, video annotations as well as software.

The memory 263 and storage 264 may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The storage 264 may include, or may constitute, a “computer-readable medium”. The storage 264 may store the instructions, code, code segments, software, firmware, programs, applications, apps, services, daemons, or the like that are executed by the CPU 261. The storage 264 may also store settings, data, documents, sound files, photographs, movies, images, databases, and the like.

In an alternate embodiment, instead of using the Mini PCI Express Adapter board 250, a USB 3.0 interface may be provided on the standard PC tablet 260.

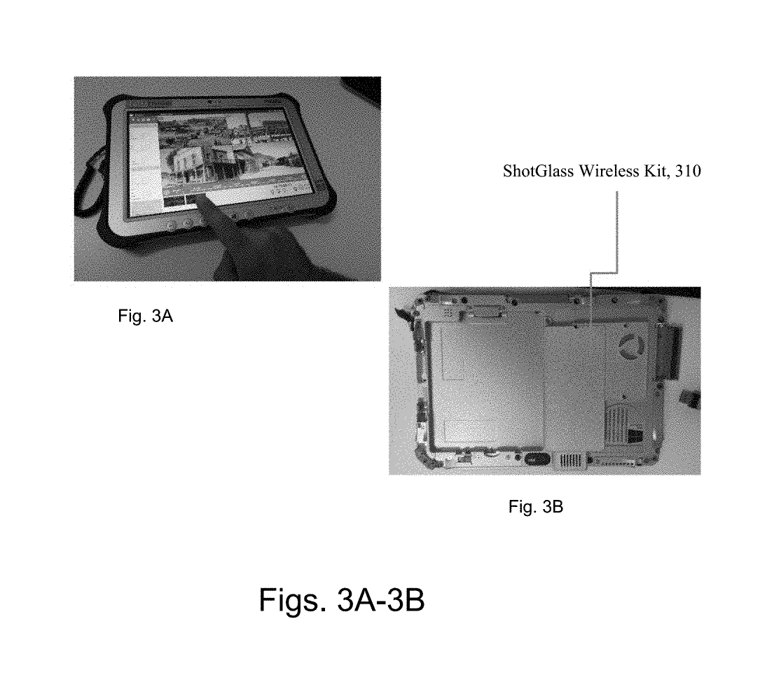

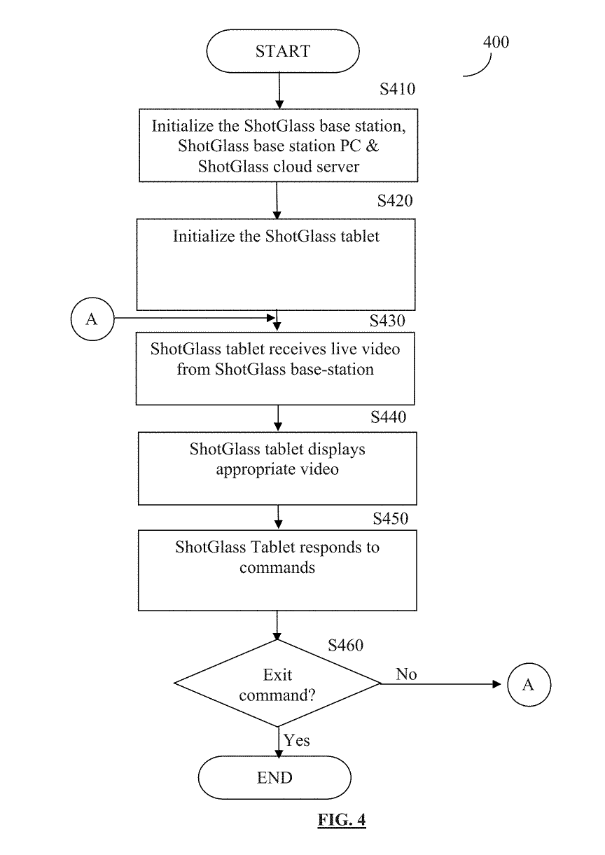

FIG. 3a is an exemplary picture showing the front-view of an embodiment of the mobile tablet. FIG. 3b is an exemplary picture showing the rear-view of an embodiment of the mobile tablet. PC boards 210, 220, 230, 240 and 250 of FIG. 2 form wireless kit 310 shown in FIG. 3b.

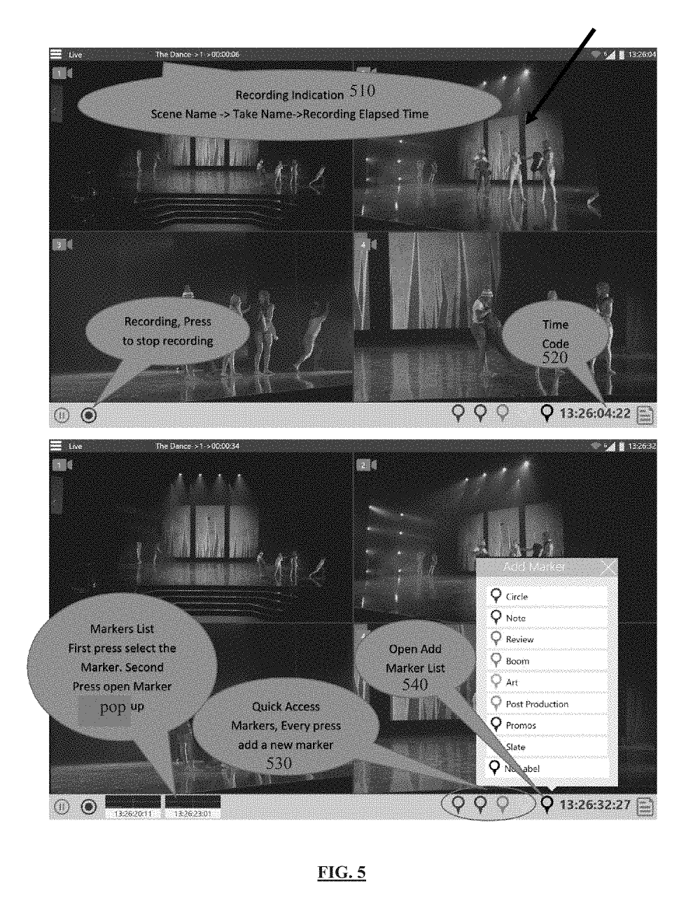

FIG. 4 is an exemplary flow chart showing a process for monitoring and annotating live video in the system.

The process begins by turning on and initializing the equipment (block S410). The remote cloud server is normally powered on and supports multiple video productions. The base station and base station PC for a specific video production are powered on. An operator logs in to the base station PC and the base station PC communicates with remote cloud server, identifying itself. The base station establishes a connection with attached audio and video sources, which typically includes microphones and video cameras.

The mobile tablet is powered on and a user logs in (block S420). The mobile tablet loads configuration options and allows the user to modify the configuration options. One of the configuration options is to define different types of markers. The mobile tablet establishes an ultra-low-latency communication link with the base station.

The mobile tablet receives live, ultra-low-latency video and audio from the base station (block S430).

The mobile tablet displays the video on the mobile tablet display (block S440).

The mobile tablet responds to user commands (block S450). User commands include but are not limited to:
Change the display of the video sources
Select audio channels for record and playback
Start or end recording of video “takes”
Add or edit markers.
Playback previously recorded audio and video.
Add or edit textual and/or graphical video annotations.
Import textual documents into the tablet, annotate and edit them
Select browsing options to enable viewing of content from the internet, either side by side with the video and audio content or full screen without the imagery.

The mobile tablet transmits any newly entered meta-data (e.g, video markers, textual and/or graphical video annotations) to other mobile tablets and to the cloud server. The mobile tablet checks if the entered user command (block S450) is an ‘exit’ command (block S460). If the mobile tablet detects an ‘exit’ command it logs out the user. If the mobile tablet detects a different command it loops back to block S430. In some embodiments, the mobile tablet sends the metadata directly to the cloud server (or via the base station PC) using, for example, a standard Wifi connection. In some embodiments, the mobile tablet sends the metadata to other mobile tablets using, for example, a standard Wifi connection. When a mobile tablet receives the metadata, it updates its display and metadata database.

FIG. 5 shows two exemplary screenshots of a mobile platform display during live recording. The upper screenshot shows the display of live video from four cameras, with upper right quadrant showing the video 505 from camera 2. The recording indication 510 identifies the scene by name and gives the “take” name and recording elapsed time. The time-code 520 uniquely identifies the time point of the displayed video. The lower screenshot illustrates the use of markers. Quick access marker icons 530 allow a user to quickly add a commonly used marker. The “add marker” icon 540 allows the user to add different types of markers by selecting from a pop-up menu.

The live video production monitoring and control system provides synchronization of video with a script. The mobile tablet displays the script side-by-side with video feeds of single or multiple video cameras with imperceptible delay. The mobile tablet allows a script supervisor, or other user, to synchronize video with the script during both live video camera recording and after recording has finished. The mobile tablet allows a user to play back video starting from a specified script location, making it easy to check continuity.

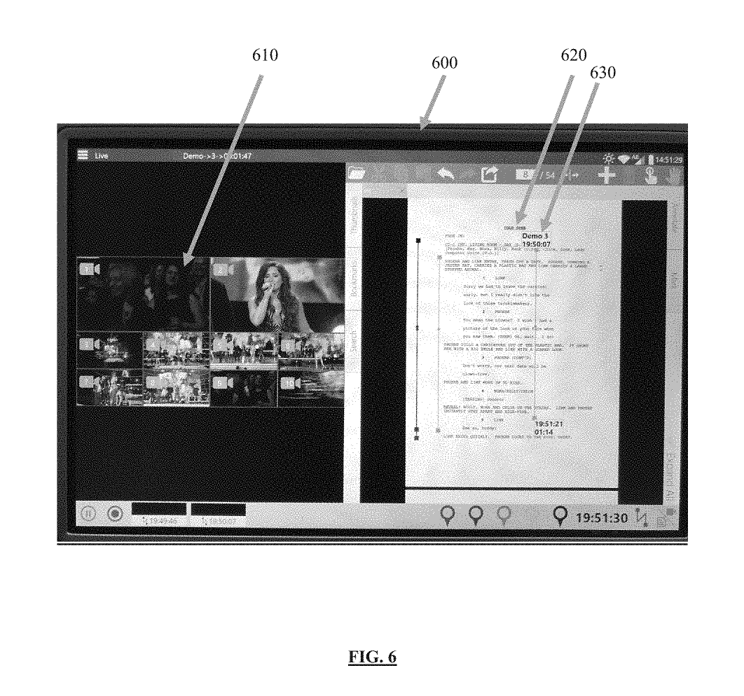

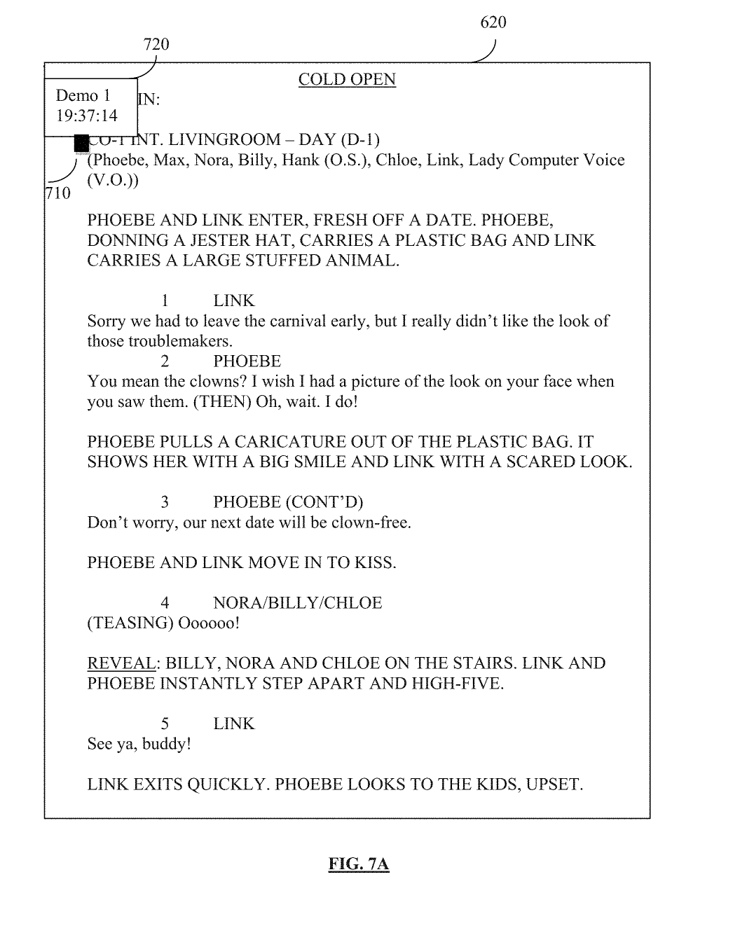

FIG. 6 shows an exemplary mobile tablet screenshot 600 of a script being synchronized with live video. The screen shot 600 shows a video window 610 on the left-hand side of the screen and a script window 620 on the right-hand side of the screen. In this example, the video window 610 is showing the live video feeds of ten different cameras, each of which is being recorded. The script window 620 shows a script overlaid with multiple polylines 630. The polylines 630 represent different video-shootings as explained later. The mobile tablet user has command options which include: a) change the video window 610 configuration, e.g., to show a different number of cameras; b) change the script window 620 configuration, e.g., specify a new script file and/or change the currently viewed location within the script; c) switch between script-annotation mode and playback mode; and d) specify the current scene name, current video-take name and optionally specify a video-shooting name.

The synchronization of video and script features is implemented in software on the mobile tablet and takes advantage of the ultra-low latency provided by the system.

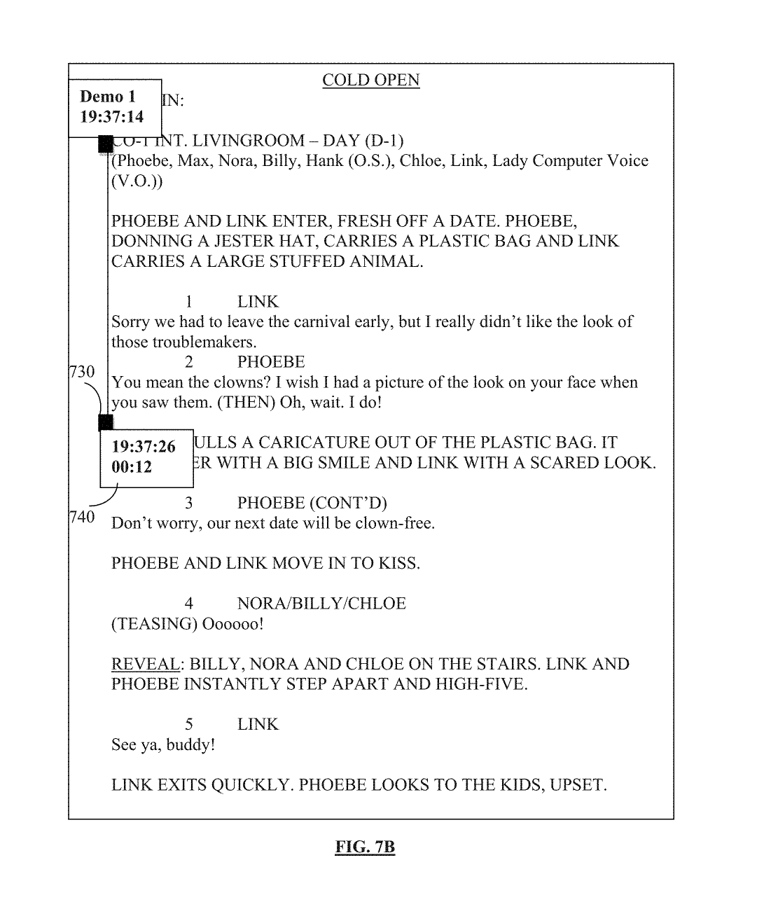

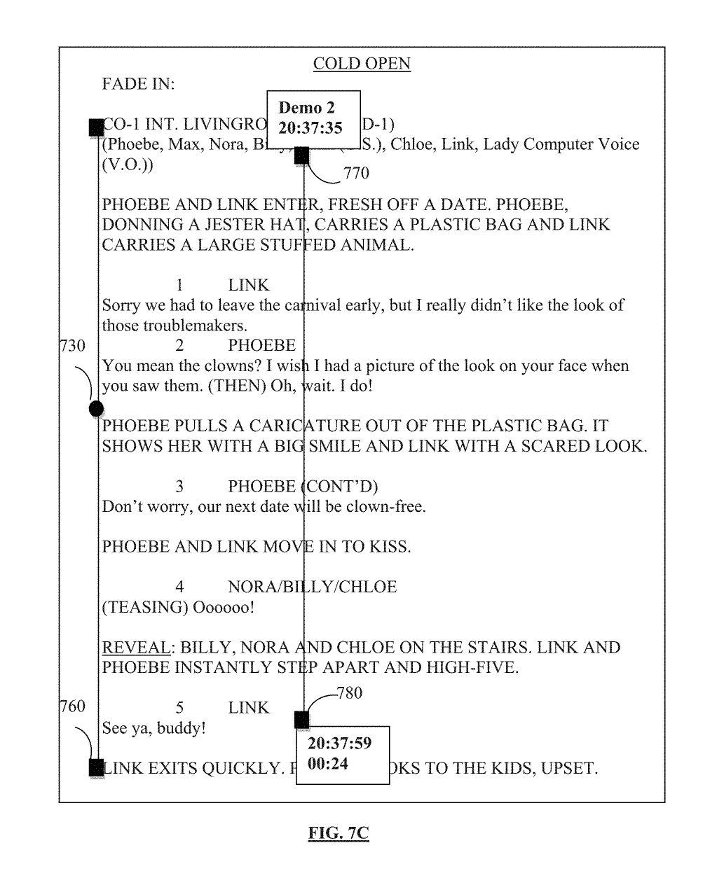

FIGS. 7a, 7b, and 7c show exemplary views of a script being successively synchronized with video. FIG. 7a shows a script with a synchronization point in an exemplary mobile tablet script window 620. The user taps on the script window to create a synchronization point 710. In this exemplary system, the mobile tablet shows the synchronization point 710 by showing a filled-in square. The mobile tablet displays label 720 next to synchronization point 710. Label 720 identifies the scene, video-take and current video time. The current video time is taken from the video timecode. In this example, the scene name is “demo”, the video-take is called “1” and the video time is “19:37:14”. The mobile tablet creates a link between synchronization point 710 of the script and the video at time “19:37:14”.

FIG. 7b shows the exemplary mobile tablet script window 620 after a user has added a second synchronization point 730. The user taps on the script window a second time to create synchronization point 730. The mobile tablet shows the synchronization point 730 by showing a filled-in square. The mobile tablet displays label 740 next to synchronization point 730. Label 740 displays the video time and the time duration since the start of video-shooting. The mobile tablet draws a line connecting synchronization points 710 and 730—a polyline.

FIG. 7c shows the exemplary mobile tablet script window 620 after a user has added three more synchronization points 760, 770 and 780. The user taps on the script window a third time to create synchronization point 760 and extend the polyline. The mobile tablet displays starting and ending synchronization points 710, 760, for example, as filled-in squares. The mobile tablet displays intermediate synchronization points 730, for example, as filled-in circles. After a break, the production team may decide to reshoot the scene as a new video-take. A user taps the script window at the start of the scene creating synchronization point 770. When the scene is finished, the user taps the script window at the end of the scene creating synchronization point 780. The mobile tablet usually shows different video-takes as polylines of different colors.

The example of FIGS. 7a, 7b and 7c show two polylines corresponding to two video-takes. The mobile tablet can support any number of video-takes and video-shootings. In one configuration, the mobile tablet displays all polylines corresponding to video-shootings within the current take and a single combined polyline for each of the previous video-takes.

Specific implementation details such as the use of filled-in squares, filled-in circles and polylines provide one example of the many possible ways of visualizing the script to video synchronization.

A mobile tablet user can check for continuity while the mobile tablet is still recording. The user clicks at the appropriate point on the polyline corresponding to the desired video-take or video-shooting. The mobile tablet determines the video start time for a specific point in the script by linear interpolating between the video times of the nearest surrounding synchronization points. During video playback, the mobile tablet indicates the corresponding script position. In one playback configuration, the mobile tablet shows the script position by changing the color of the polyline, so that unplayed video has a different color to already played video. In a different embodiment, mobile tablet shows the script position by displaying a pointer at the appropriate location.

In normal practice, one person creates synchronization points on the script. When required, multiple people, each with their own mobile tablet, can create synchronization points. Users also add comments to the script. Each mobile tablet communicates its synchronization points and user-comments to other mobile tablets working on the same production. This allows one person to maintain the script to video synchronization while other people check for continuity.

When checking for continuity, a user may view a single, previous video-shooting or may view a pair of previous video-shootings side-by-side. Viewing a pair of video-shooting side-by-side makes it easy to compare the two recordings.

The mobile tablet has commands that allow a user to add, delete or move synchronization points; either during live recording or after recording has finished.

During a video production, the production team usually makes many changes to the script. The mobile tablet has the ability to support live updating of the script (i.e., during recording) and script replacement. Script changes are often made after a day's shooting is competed and the script supervisor replaces the old script at the start of the new day's shooting. The mobile tablet checks to see where script text has been added and where script text has been removed. Comments and synchronization points belonging to unchanged text lines are kept. Comments and synchronization points belonging to deleted text lines are normally removed but can be viewed on request.

Using a camera on the mobile tablet, a user can insert photos into the script or into a document. These photos can also be fully annotated with text and free-hand sketches as a telestrator function.

Although the described system uses a mobile tablet platform to synchronize video with a script, a different system embodiment could use a different platform, such as a personal computer with low latency video provided by a video capture card. In this case the personal computer platform would synchronize video with a script.

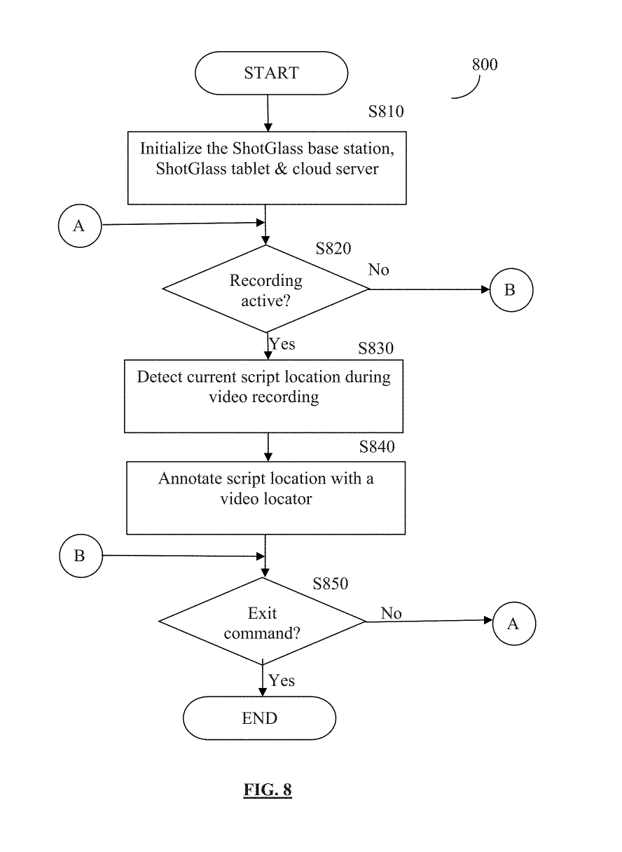

FIG. 8 is an exemplary flow chart illustrating a process for synchronizing live video with a script in the system. The base station, the tablet and the cloud server are powered up and initialized (block S810). They may be powered up and initialized as described earlier with respect to FIG. 4 (S410). The user may open a script file and locate the scene to be shot within the script. The user identifies the scene name and optionally provides a video-take name. The user selects the “start recording” command.

The tablet checks if video recording is still active (block S820). If video recording is no longer active, the process continues to block S850. If video recording is active, the process continues to block S830. At block 830, the tablet detects the current script location. In one configuration, the tablet detects the current script location using a user's screen taps. In a second configuration, the tablet detects the current script location automatically by analyzing the audio. The tablet detects speech in the audio and either a) identifies a change of speaker; b) identifies spoken words. The tablet annotates the specified script location with a video locator known as a synchronization point (block S840). If this is the first synchronization point, the tablet starts a new video-take and labels the synchronization point with the scene name, video-take name and video time taken from the video timecode. If this is not the first synchronization point and the new synchronization point location is later in the script, the tablet creates (or adds to) a polyline, and labels the synchronization point with the current video time and time duration. If this is not the first synchronization point and the new synchronization point location is earlier in the script, the tablet starts a new polyline for a new video-take or video-shooting. The tablet checks if the user has issued an exit command (block S850). If the user has issued an exit command the tablet exits. If the user has not issued an exit command the tablet continues to block S820.

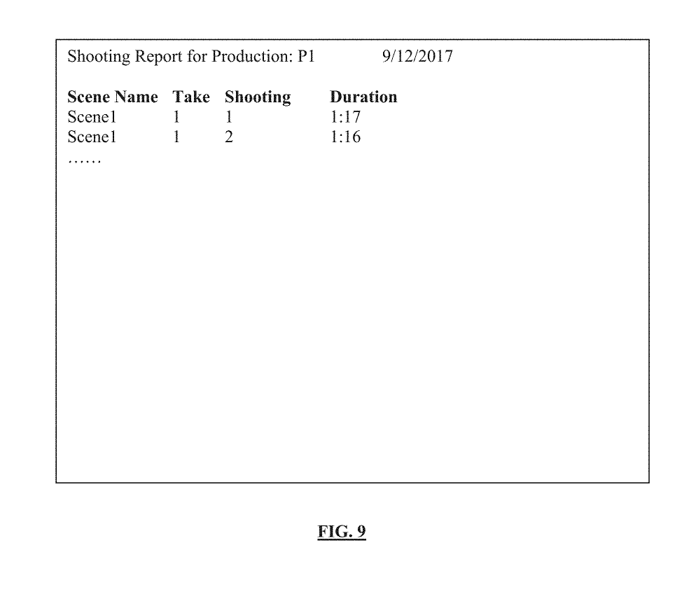

FIG. 9 shows an exemplary shooting report. For budgeting and scheduling reasons, the production team is often required to create a daily shooting report, also called a shot-log. The shooting report lists scenes, video-takes and video-shootings giving the duration of each. The system automatically produces a shooting report.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture.

1. An interactive live video production monitoring and control system comprising:
a video source;
an interactive mobile tablet, the interactive mobile tablet comprising a first ultra-low-latency wireless chip; and
a base station connected to the video source, the base station comprising a second ultra-low-latency wireless chip,
wherein the base station transmits video from the video source to the interactive mobile tablet using ultra low-latency wireless communication, and
wherein the mobile tablet detects a script location for the video in real time and annotates the script with a video locator corresponding to a first synchronization point based on the detected script location.

2. The system of claim 1, wherein the mobile tablet detects the script location for the video in real time by receiving input from a user.

3. The system of claim 1, wherein the mobile tablet detects the script location for the video in real time by detecting at least one of: speech in detected audio, a change of speaker in the detected audio, and spoken words within the detected audio.

4. The system of claim 1, wherein the interactive mobile tablet plays feeds of the video source with imperceptible delay.

5. The system of claim 4, wherein the interactive mobile tablet is adapted to allow a user to view recorded video from one or more video sources based on the first synchronization point.

6. The system of claim 5, wherein the interactive mobile tablet is further adapted to allow the user to annotate segments of video on the interactive mobile tablet.

7. The system of claim 5, further comprising a second interactive mobile tablet connected to the interactive mobile tablet and receive the annotated segments of video from the interactive mobile tablet.

8. The system of claim 1, wherein the interactive mobile tablet is further adapted to allow a user to view live video and recorded video from one or more video sources simultaneously.

9. The system of claim 1, wherein the video latency from the video source to the interactive mobile tablet is between 1-7 frames.

10. The system of claim 1, wherein the interactive mobile tablet comprises an ultra-low-latency wireless chip.

11. The system of claim 1, wherein the mobile tablet repeats the detecting and annotating at a second synchronization point, the second synchronization point being at a different time than the first synchronization point; and displays a polyline connecting the first synchronization point with the second synchronization point.

12. The system of claim 1, wherein the mobile tablet annotates the video at the first synchronization point with a scene name, video-take name and video time.

13. The system of claim 1, wherein the mobile interactive tablet is configured to send metadata created on the mobile interactive tablet to other mobile interactive tablets and to the cloud server for access by remote users.

14. The system of claim 1, wherein the mobile interactive tablet comprises memory for storing video locally, and wherein the mobile interactive tablet is configured to allow playback of the video from the memory.

15. A method for interactive live video production monitoring and control comprising:
establishing a low-latency communication link with a base station, the base station connected to a video source;
receiving ultra-low latency video from the video source through the base station in real time;
displaying the video from the video source on a display;
detecting a script location for the video in real time; and
annotating the script with a video locator corresponding to a first synchronization point based on the detected script location.

16. The method of claim 15, wherein the base station is further connected to an audio source, and wherein the method further comprising:
delivering the audio from the audio source on a speaker.

17. The method of claim 15, further comprising receiving a user command, wherein the user command is selected from the group consisting of:
change the display of the video sources;
start or end recording of video takes;
add or edit markers;
playback previously recorded video;
add or edit textual and/or graphical video annotations;
import textual documents into the tablet, annotate and edit the textual documents; and
select browsing options to enable viewing of content from the Internet.

18. The method of claim 17, wherein the user command further comprises import a revised script document into the tablet, and update the revised script with synchronization markers and annotations.

19. The method of claim 15, further comprising annotating the video at the first synchronization point with a scene name, video-take name and video time.

20. The method of claim 15, further comprising:
repeating the detecting and annotating at a second synchronization point, the second synchronization point being at a different time than the first synchronization point; and
generating a polyline connecting the first synchronization point with the second synchronization point.

21. A computer readable hardware medium with executable instructions stored thereon, which when executed by a computer processor, cause said computer to execute a method for interactive live video production monitoring and control comprising, the method comprising:
establishing a low-latency communication link with a base station, the base station connected to a video source;
receiving ultra-low latency video from the video source through the base station in real time;
displaying the video from the video source on a display; detecting a script location for the video in real time; and
annotating the script with a video locator corresponding to the detected script location.
